(19) United States
(12) Patent Application Publication
(10) Pub. No.: US 2026/0080749 A1
(43) Pub. Date: Mar. 19, 2026

(54) GAMING SYSTEMS AND METHODS WITH LINKED AWARD FEATURE

(71) Applicant: LNW Gaming, Inc., Las Vegas, NV (US)

(72) Inventors: Michael W. TUCKER, Chicago, IL (US); Jeffry L. NAUMAN, Panama City Beach, FL (US); Matthew ZWOLINSKI, Oak Lawn, IL (US)

(21) Appl. No.: 19/316,223

(22) Filed: Sep. 2, 2025

Related U.S. Application Data
(60) Provisional application No. 63/695,422, filed on Sep. 17, 2024.

(51) Int. Cl. G07F 17/32

(52) U.S. Cl. CPC G07F 17/3267; G07F 17/3213

(57) ABSTRACT

There is provided a gaming system, gaming machine, and method that utilize a presentation assembly configured to present a game interface including a plurality of symbol positions and a set of available awards, present a game outcome by populating the symbol positions with randomly selected symbols, and, in response to detecting a collection event based on the randomly selected symbols, (i) remove a plurality of award elements associated with the collection event from the set of available awards, and (ii) present a new award element within the set of available awards that has award indicia visually indicating a new award at least partially as a function of the awards associated with the plurality of award elements. The presentation assembly is further configured to, in response to detecting an award event associated with the new award element from a subsequent game outcome, present an award sequence for the new award.

### CROSS-REFERENCE TO RELATED APPLICATIONS

This application claims the benefit of priority to U.S. Provisional Application No. 63/695,422, filed Sep. 17, 2024, the contents of which are incorporated herein by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to a technological improvement to gaming systems, gaming machines, and methods and, more particularly, to new and improved animations in connection with a linked award feature for generating new awards based on existing and/or collected awards.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present disclosure, there is provided a gaming system, gaming machine, and method that utilize game-logic circuitry in communication with a presentation assembly configured to present a game interface including a plurality of symbol positions and a set of available awards separate from the plurality of symbol positions, each award of the set of available awards visually indicated by award indicia of a respective award element. The game-logic circuitry is configured to cause the presentation assembly to present a game outcome by populating, via one or more animations, the plurality of symbol positions with randomly selected symbols, cause, in response to detecting a collection event based on the randomly selected symbols, the presentation assembly to: (i) remove a plurality of award elements associated with the collection event from the set of available awards presented on the game interface, and (ii) present a new award element within the set of available awards, the new award element having award indicia visually indicating a new award at least partially as a function of the awards associated with the plurality of award elements, and cause, in response to detecting an award event associated with the new award element from a subsequent game outcome, the presentation assembly to present an award sequence for the new award.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present disclosure.

FIG. 2 is a block diagram of a gaming system according to an embodiment of the present invention.

FIG. 3 is a data flow diagram of an example method of operating a gaming system using award collection events, according to an embodiment of the present disclosure.

FIG. 4 is a data flow diagram of an example method of operating a gaming system using award collection events and award queue, according to an embodiment of the present disclosure.

FIG. 5A is an example game interface of a gaming system in a first state with a set of available awards, according to an embodiment of the present disclosure.

FIG. 5B is the game interface shown in FIG. 5A in a second state with a collection symbol, according to an embodiment of the present disclosure.

FIG. 5C is the game interface shown in FIG. 5A in a third state with a collected award, according to an embodiment of the present disclosure.

FIG. 5D is the game interface shown in FIG. 5A in a fourth state with an aggregate collection symbol, according to an embodiment of the present disclosure.

FIG. 5E is the game interface shown in FIG. 5A in a fifth state with a collected aggregate award, according to an embodiment of the present disclosure.

FIG. 5F is the game interface shown in FIG. 5A in a sixth state with newly added award based on a collected award, according to an embodiment of the present disclosure.

FIG. 5G is the game interface shown in FIG. 5A in a seventh state with a dynamic award element, according to an embodiment of the present disclosure.

FIG. 5H is the game interface shown in FIG. 5A in an eighth state with a collected dynamic award, according to an embodiment of the present disclosure.

FIG. 6A is an example game interface in a first state with a plurality of modifier and special symbols affecting a set of available awards, according to an embodiment of the present disclosure.

FIG. 6B is the game interface shown in FIG. 6A in a second state depicting the effect of the symbols from the first state on the available awards.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Embodiments of the present invention comprise an innovative application of data processing steps that, when implemented by game-logic circuitry, direct an electronic display device to present a symbol-value collection and generation process that minimizes processing overhead by utilizing numbered indicia to represent credit values instead of complex, fanciful game images. Further, the process generates new values as a function of displayed values borne by special symbols (i.e., value-bearing symbols) according to stored, variable criteria. In this way, the value-bearing symbols provide building blocks for innumerable different value generation sequences simply by manipulating the generation criteria associated with the value-bearing symbols, resulting in fewer rules needed for the generation process than would be necessary for calculating values of winning symbol combinations enumerated in stored paytables, as found in prior art reel-spinning routines. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-generation process that can be easily adapted to any theme/brand while remaining easily understood by players.

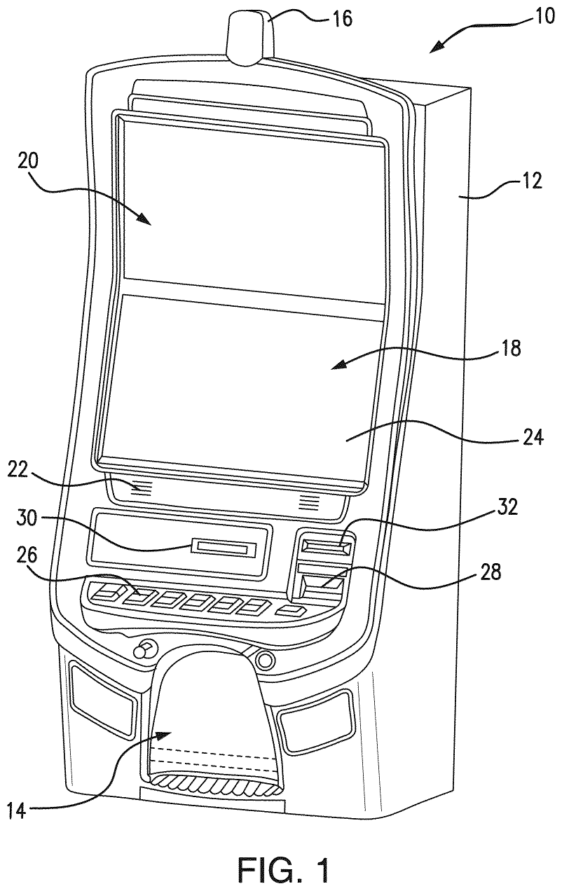

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

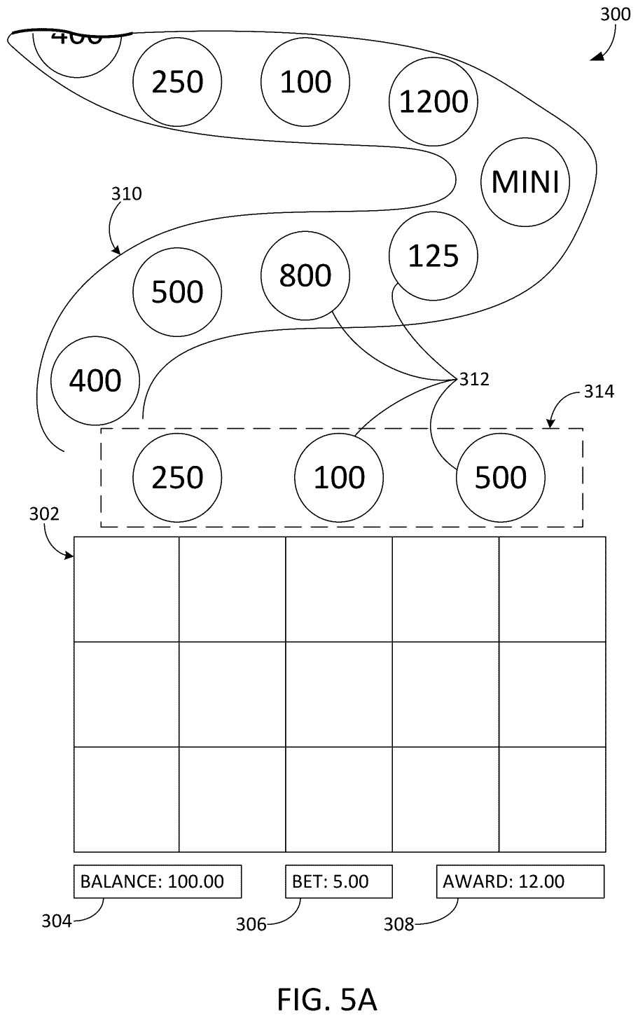

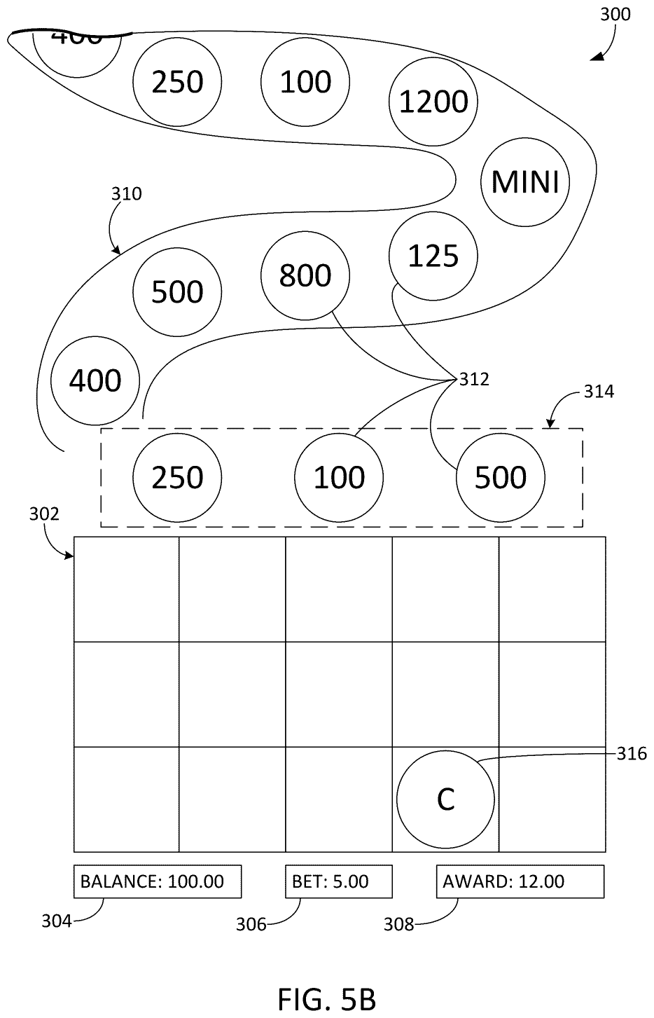

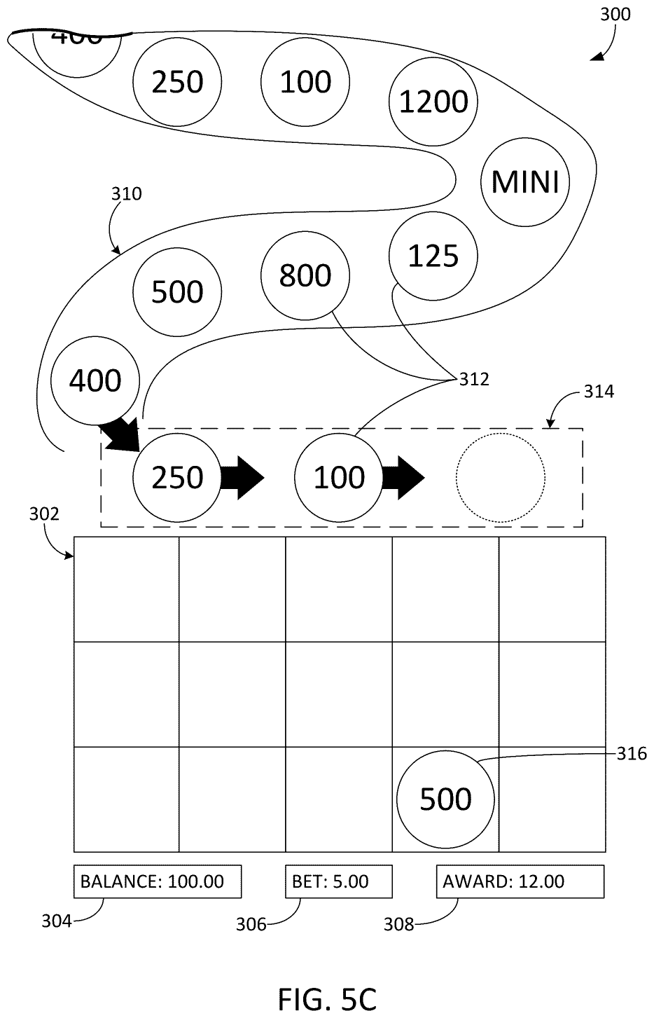

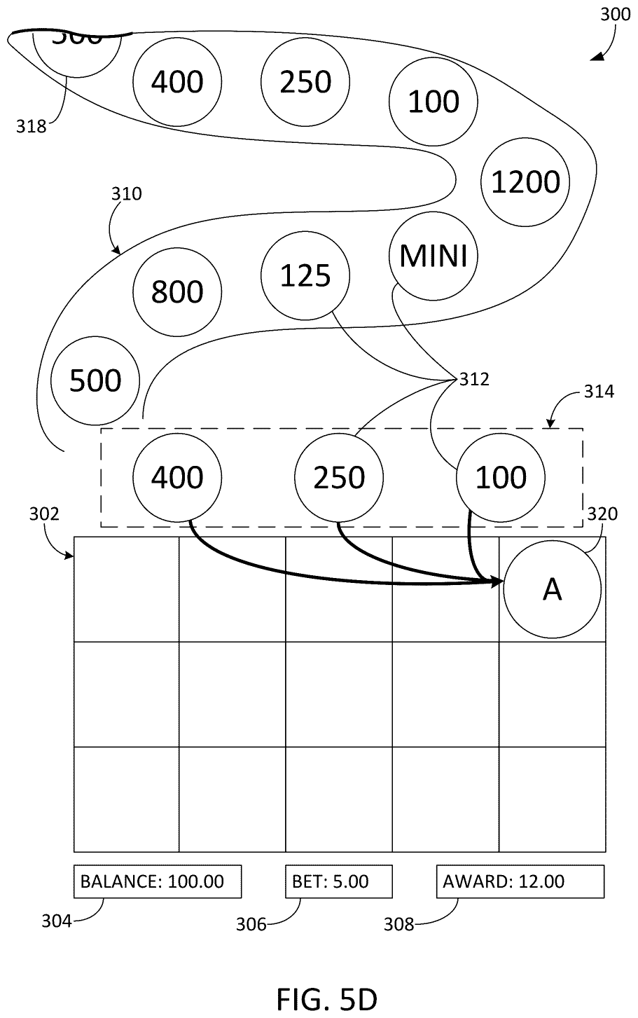

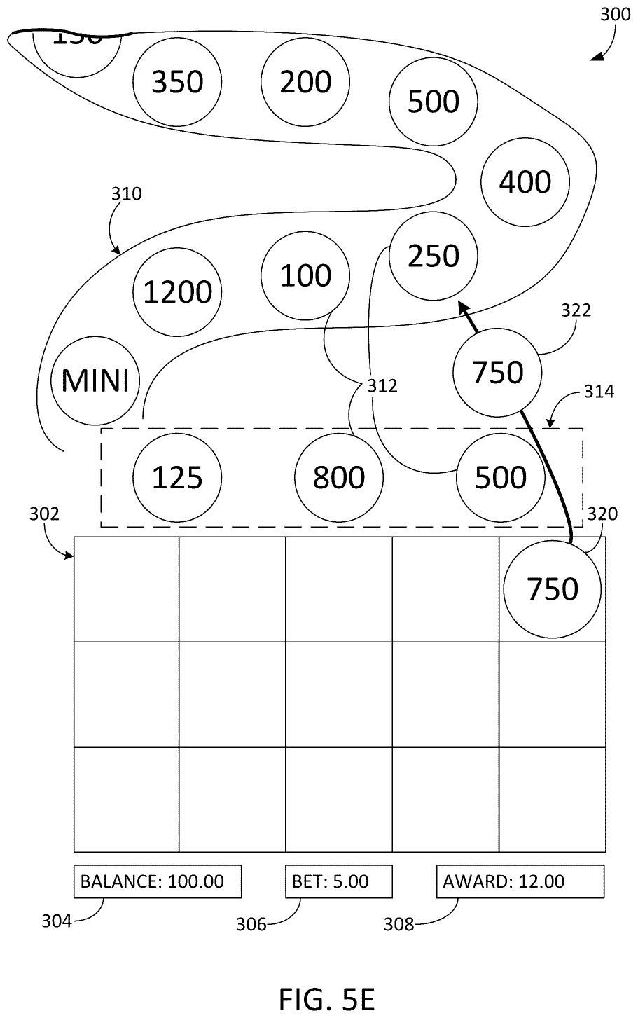

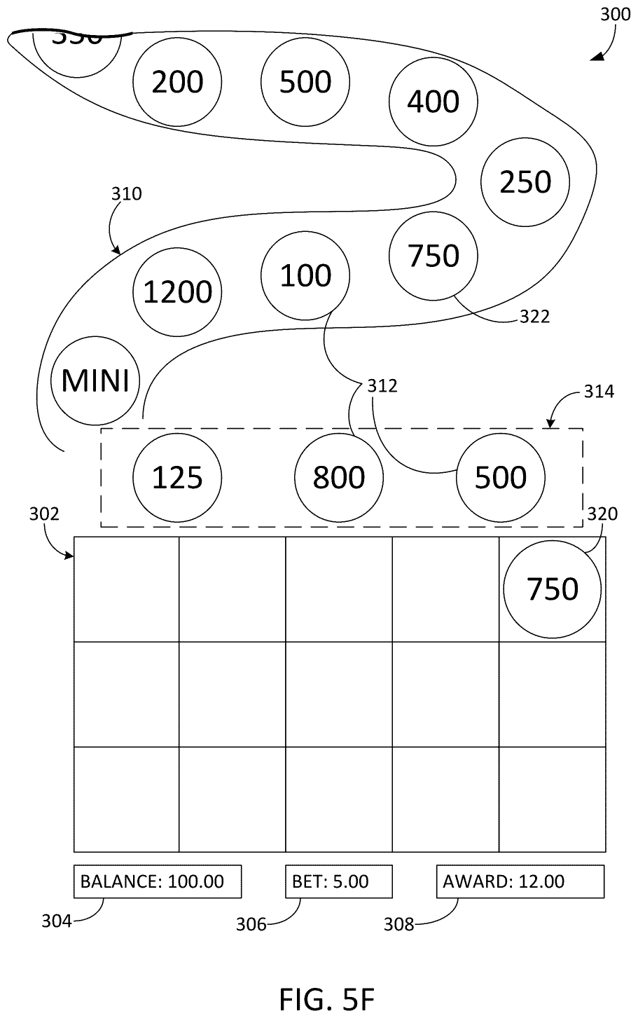

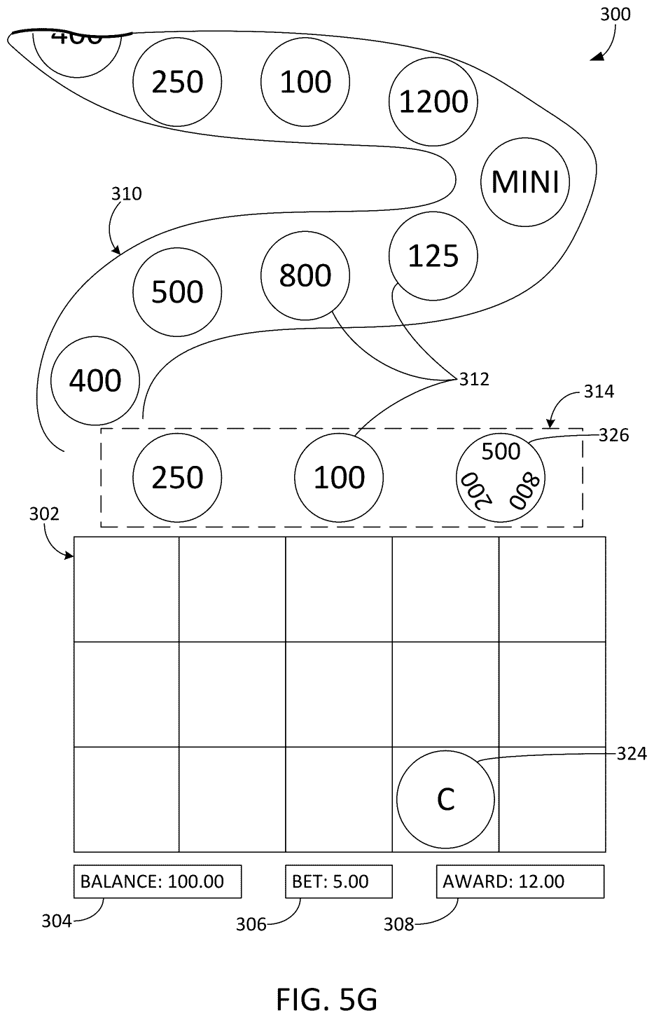

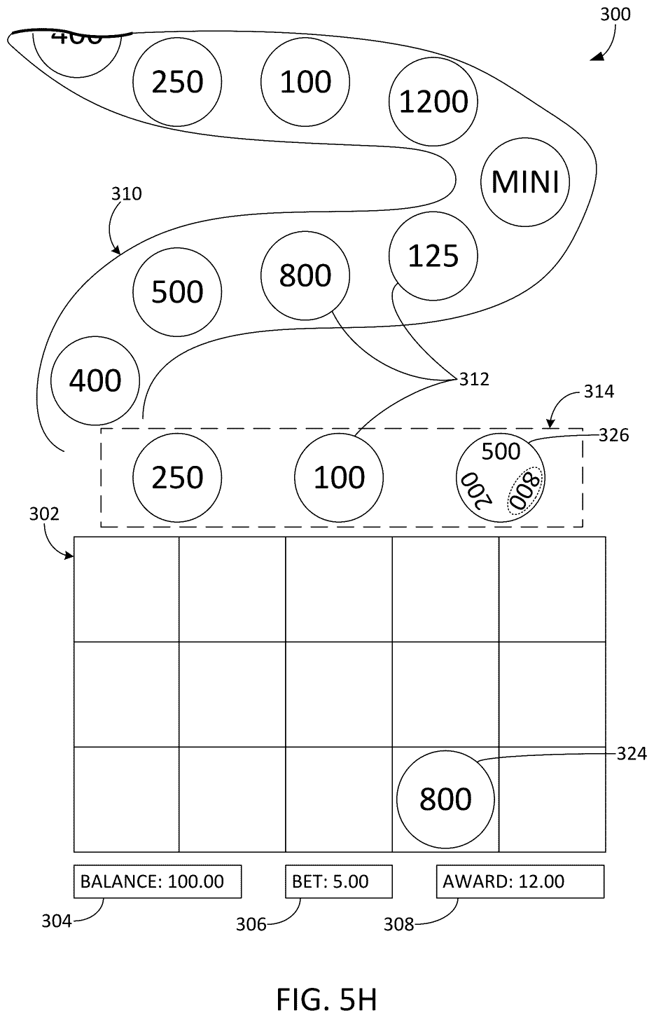

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 304 (see FIGS. 5A-5H). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 304 (see FIGS. 5A-5H), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

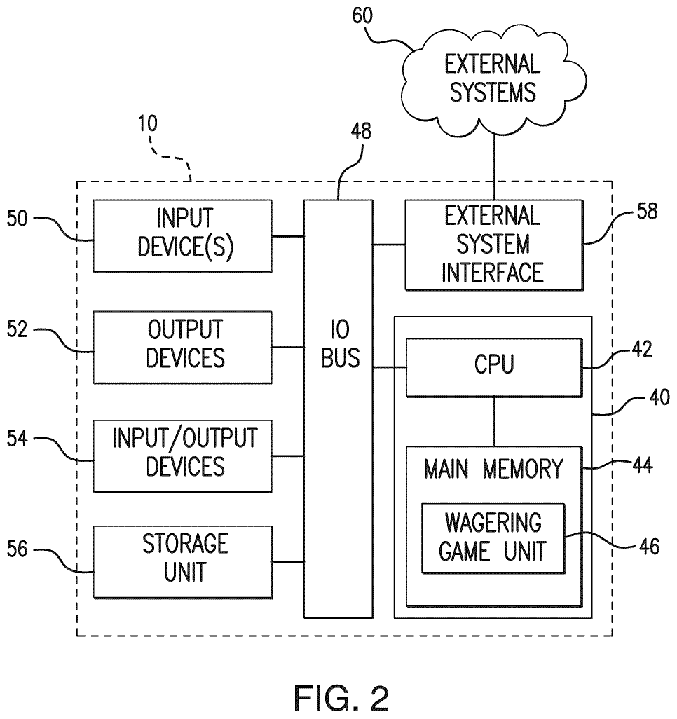

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

The systems and methods described herein include innovative animations and functionality associated with linked awards, where new awards are generated at least partially as a function of one or more available or collected awards. In particular, the systems and methods described herein include a set of available awards external to a plurality of symbol positions (e.g., a symbol array) that, in response to a corresponding trigger event, causes one or more awards to be selected and provided from the set. The selected awards may be awarded, added to a value-bearing symbol, and/or incorporated into the specific configuration of the underlying game. The selected awards are also used to generate new awards to be added to the set of awards, such as an aggregate value of the awards that provides an exciting opportunity to build higher-valued awards within the set of awards. The embodiments described herein may organize the set of the awards into a queue for selection, where the new award is inserted into the queue and the selected awards are removed.

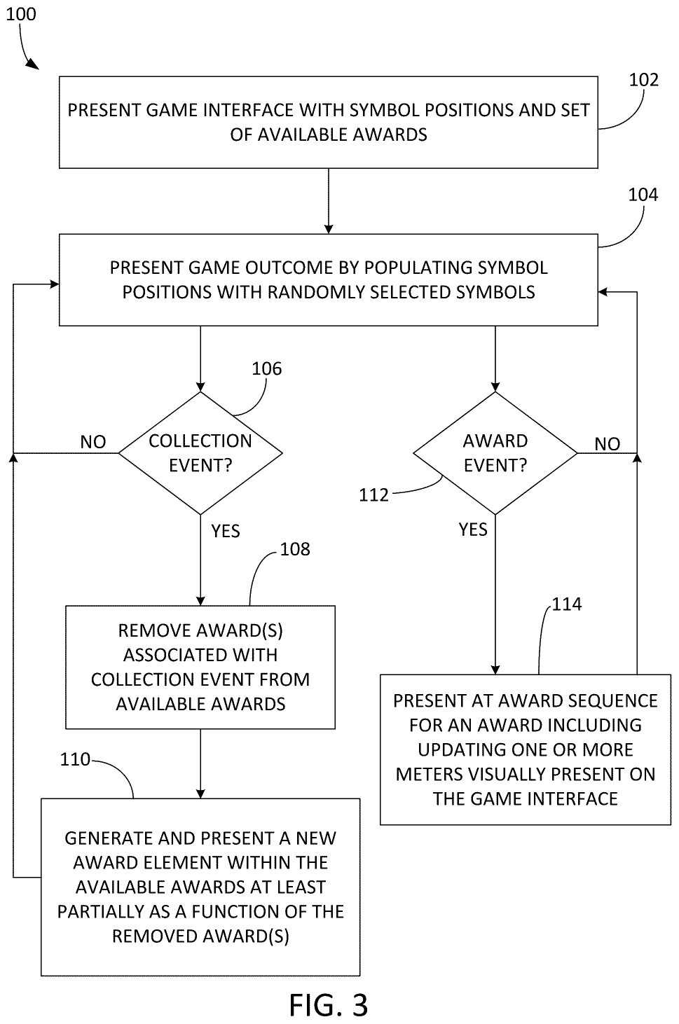

FIG. 3 depicts a flow diagram of an example method 100 for operating a gaming machine of a gaming system, such as the machine and system shown in FIGS. 1 and 2, according to present disclosure. More specifically, the method 100 is associated with a linked award functionality for generating and presenting new awards. The method 100 is at least partially performed by a presentation assembly of the gaming machine and game-logic circuitry of the gaming system that is communicatively coupled with the presentation assembly to cause the assembly to perform the functionality associated with the method 100 as described herein. The game-logic circuitry may be fully integrated, partially integrated, or physically independent from the gaming machine. For example, the game-logic circuitry may include circuitry within the gaming machine and circuitry within a gaming server in data communication with the gaming machine. In other embodiments, the method 100 is performed by another configuration of devices associated with the gaming system and/or includes additional, fewer, or alternative steps, including those devices and steps described elsewhere herein.

The method 100 is associated with a wagering game presented via the gaming machine that includes a base game and a bonus game accessible through game events and/or conditions detected within the base game. In other embodiments, the method 100 is associated with a non-wagering game. It is to be understood that the method 100 and other aspects of the systems and methods described herein may be adapted to various configurations of wagering and non-wagering games.

In the example embodiment, a gaming session for the wagering game is initiated by a player at the gaming machine. More specifically, the player establishes a credit balance and/or links the gaming session to a player account. The credit balance may be established via the player providing one or more physical credit inputs (e.g., bills, coins, tickets, cards, etc.) to a corresponding credit input device of the gaming machine, or the player may link a digital account or wallet to the gaming session. Credits provided to the gaming session are visually presented via one or more meters displayed by the presentation assembly of the gaming machine. For non-wagering games, the gaming session may be initiated without requiring a credit balance to be established or an alternative balance is established (e.g., an allocated period of time or a non-monetary balance is provided) to facilitate the gaming session.

In addition to the credit meter, the presentation assembly is configured to present a game interface associated with the base game for visually depicting play of the base game. In at least some embodiments, the base game interface includes a plurality of symbol positions that are selectively occupied by randomly selected symbols during each outcome of the base game. In certain embodiments, the symbol positions are arranged into one or more symbol arrays. Additionally or alternatively, other suitable game and/or presentation elements may be included within the base game interface to facilitate various configurations of the base game. For example, the base game interface may include one or more meters other than the credit meter, such as a bet meter and/or an award meter. In another example, one or more persistent elements external to the symbol array are presented to provide additional game functions as described herein.

In the example embodiment, the method 100 is associated with a bonus game associated with the base game. More specifically, a trigger event occurring within the base game causes the bonus game to be initiated. In some examples, a base game outcome includes populating the symbol positions with randomly selected symbols, and the trigger event is at least partially based on the symbols occupying the symbol positions. For example, and without limitation, the trigger event may include detecting one or more trigger symbols, a trigger combination of symbols, one or more symbols occupying trigger symbol position, and/or other suitable events detectable based on the symbols and/or symbol positions. The bonus game includes a plurality of spins or game outcomes that do not require wagers. Rather, the bonus game has a limited duration as described herein before concluding and resuming the base game or other suitable game of the gaming session. In other embodiments, the method 100 is associated with the base game. In such embodiments, the method 100 may be adjusted to facilitate the wager and credit balance-based duration (or other suitable forms of duration, such as for non-wagering games) of the base game.

In the example embodiment, in response to a trigger event being detected in the base game, the presentation assembly is configured to animate a transition sequence of the game interface from a base game interface to a bonus game interface for initiating the bonus game. More specifically, at step 102, the bonus game interface is presented with a plurality of symbol positions and a set of available awards. The symbol positions of the bonus game interface may be the same or at least partially different from the symbol positions of the base game interface. In one example, the symbol positions remain the same in both the base and bonus game interfaces. In another example, additional symbol positions are added within the bonus game interface, such as adding an additional row or column to the symbol array. In a further example, the number of symbol positions remains the same between the base and bonus game interfaces, but the symbol positions are arranged differently relative to the other game interface.

In the example embodiment, the set of available awards are presented external to the symbol positions. Each award may be represented by a respective award element on the bonus game interface. An award element includes one or more graphical elements that would be readily understood to visually represent a single game element (i.e., a single award or a single subset of awards). In at least some embodiments, the award elements include respective award indicia that visually indicate the respective award. The award of each award element may include, without limitation, a credit award, additional free spins or outcomes, multipliers or other modifiers, jackpots, trigger symbols (e.g., jackpot trigger symbols that, upon collecting a threshold number, triggers an award of a jackpot), and/or other suitable awards, including combinations thereof. In certain embodiments, the award indicia and/or other suitable visual elements of an award element may be hidden or otherwise have different states until a corresponding trigger event is detected. For example, the award indicia may be hidden until the award element is to be awarded.

In some embodiments, the entire set of available awards may be presented within the bonus game interface at a time. For example, a segmented award wheel may be divided into a plurality of wedges that represent different award elements, and the entire award wheel may remain visually present within the bonus game. In another example, the set of available award elements are presented within a prize board visually depicting each award element.

In other embodiments, at least a portion of the set of available awards may be hidden from the bonus game interface at a given time. In one example with an award wheel, a portion of the award wheel may be hidden from view such that the wedges are animated to alternate between being hidden and viewable during a spin animation. In certain embodiments, the set of available awards are presented within the bonus game interface within a queue or other suitable graphical representation of an ordered progression of the available awards as described in detail herein.

At step 104, the bonus game begins with the presentation assembly presenting a bonus game outcome generated by the game-logic circuitry. More specifically, the bonus game outcome is presented at least partially by populating the symbol positions with randomly selected symbols from the one or more sets of available symbols associated with the bonus game. In at least some embodiments, the symbols are presented via one or more symbol-bearing reel strips that are animated to spin and stop such that one or more symbols of the reel strip are presented in one or more corresponding symbol positions. For example, one reel strip may be associated with a single symbol position or a single column of a symbol array. It is to be understood that “populating the symbol positions with randomly selected symbols” includes embodiments in which some or all symbol positions may not be populated by a symbol (i.e., a “blank” symbol position) for a given game outcome. In some embodiments, additional or alternative game elements may be incorporated into the generated game outcome, and the presentation assembly is configured to present a corresponding outcome sequence to visually convey the state of the game outcome.

In response to generating a bonus game outcome, the game-logic circuitry is configured to perform one or more outcome determinations. The outcome determinations include predefined parameters stored by the game-logic circuitry that are compared to the current state of the game, such as the symbols forming the game outcome. Two example outcome determinations are shown at steps 106 and 112. Additional or alternative outcome determinations may be performed by the game-logic circuitry in at least some embodiments. Outcome determinations may be performed sequentially, in parallel, or combinations thereof. The outcome determinations may be performed prior to, during, or after one or more animations of the outcome sequence presented by the presentation assembly.

At step 106, the game-logic circuitry determines whether or not a collection event is present within the bonus game outcome. The predefined criteria or parameters associated with collection events are stored by the game-logic circuitry and compared to the game elements of the bonus game outcome, such as the symbols populating the symbol positions. In at least some embodiments, the collection event includes detecting one or more collection symbols within the symbol positions. The collection symbols may be dedicated to triggering collection events or include other suitable game functions, such as being available for symbol combination awards (e.g., line pays or scatter pays). If no collection event is detected, the game-logic circuitry performs any remaining outcome determinations, such as the determination at step 112, before proceeding to the next bonus game outcome at step 102.

In at least some embodiments, the bonus game has a limited duration, and the game-logic circuitry is configured to determine whether or not the duration of the bonus game has expired prior to repeating the step 104. For example, the bonus game may have a limited duration defined by a predetermined (or dynamic) number of bonus game outcomes, where the game-logic circuitry updates one or more variables stored to monitor the current state of the bonus game in response to the bonus game outcome generation associated with the step 104 and compares the stored variables to one or more predefined criteria associated with concluding (or extending, in some embodiments) the bonus game. The duration of the bonus game may be defined, for example and without limitation, by a number of game outcomes, a number of other suitable game events, a timer, and/or the like, including combinations thereof. Concluding the bonus game may include one or more presentation sequences by the presentation assembly, such as an award sequence for any awards accumulated over the duration of the bonus game and/or a transition sequence that animates the bonus game interface to transition to the base game interface or another suitable game interface.

In the example embodiment, if a collection event is detected at step 106, the method 100 proceeds to step 108. More specifically, in response to the detected collection event, a collection sequence is presented by removing one or more award elements from the set of available awards. The removed award elements are associated with the collection event, where the association may be static (i.e., predetermined) or dynamic. One example of a static or predetermined association may be shared or linked characteristics between the award elements and the game elements forming the collection event, such as the collection symbols. The dynamic association relies at least partially upon one or more aspects of the current state of the bonus game to define the association. For example, the award elements may be associated with the collection event in response to a random or partially random selection from the set or a subset of the available awards. In another example in which the awards are organized into a queue, the queue may define a subset of the available awards within a “selection region” that indicates which award elements are associated with the current collection event. In a further example, the association may be dynamically defined based on the location and/or number of collection symbols or other suitable game elements associated with the collection event.

In some embodiments, the bonus game includes different types of collection events that define the number of award elements associated with a given collection event. For example, a first type of collection event may be associated with a single award element at a time, while a second type of collection event may be associated with a plurality of award elements. The different types of collection events may have different collection symbols or require a different number of collection symbols. In other embodiments, the bonus game includes a single type of collection event, but the number of associated award elements is dependent upon one or more random determinations and/or the underlying game elements forming the collection event.

Removal or collection of the award elements associated with the collection event from the set of available awards facilitates one or more suitable game functions based on the removed awards. In at least some embodiments, the removed or collected awards are associated with one or more awards provided within the bonus game, such as an award via steps 112 and 114 as described herein. The award may be an aggregate value of the values indicated by the one or more removed award elements, or the award may be another suitable function of the removed awards. In one example, for a plurality of removed awards associated with a single collection event, one award may be selected from the plurality of removed awards to be provided to the player. In other embodiments, rather than awarding or generating an award based on the collected award elements, the collection of the award elements may provide additional or alternative game functionality. In one example, the collected or removed award elements may be applied to a progressive jackpot or other suitable progressive award that is triggered through a different trigger event, such as collecting a threshold number of jackpot symbols. In another example, the remaining award elements (i.e., those award elements that are not selected and removed from the bonus game interface) at the conclusion of the bonus game are used to generate or select an award, where it is advantageous to remove relatively smaller values from the set of available awards to increase the chance that a relatively higher value award element is selected to be provided in response to the generation or selection.

It is to be understood that the removal described with respect to the step 108 may include embodiments in which the award elements are not entirely hidden from the bonus game interface but rather updated to be presented in a manner that is visually distinct from the remaining award elements. In one example, the award indicia of a ‘removed’ award element is hidden while the award element remains, thereby visually conveying the award element is no longer associated with an available award. In another example, the removed award elements may be collected into a presentation element within the bonus game interface that is away from the set of available awards to visually convey the collection, such as a pot or stack that is animated to be filled with collected award elements.

In the example embodiment, at step 110, the game-logic circuitry generates one or more new award elements within the set of available awards at least partially as a function of the one or more removed awards from the step 108. That is, at least one new award is introduced to the set of available awards in response to the collection event. In one example, particularly for sets of available awards arranged into a queue or that include additional characteristics (e.g., one or more characteristics defining a link between each award element and the collection events), a new award element is added for each respective award element removed at the step 108. In certain embodiments, the new award elements have the same award value as the corresponding removed award element. In other embodiments, the new award elements have a value greater than the value of the corresponding removed award element. For new award elements based on multiple removed award elements, the new award element may have an award value equal to the aggregate or highest value of the removed award elements. In some embodiments, the new award element may include each value from the removed award elements such that one value is selected in response to a subsequent collection event associated with the new award element. It is to be understood that the above functions are for exemplary purposes only and are not intended to limit the functional operations performable to generate a new award element, such as operations the incorporate a random or partially random variable to generating the new award element. Any suitable mathematical, logical, or other operation (including combinations thereof) may be implemented to generate the new award element according to the specific configuration of the underlying game. Adding new award elements to the set of available awards, particularly adding new award elements having increased value relative to previously collected awards, provides a new and engaging game presentation supported by resource-efficient game logic executed by the gaming system.

In certain embodiments, the award elements may be configured to include additional or alternative game functionality, such as a number of picks from a prize board, a number of free spins, a trigger symbol, and the like. These game functions may be expressed visually via the indicia of the award elements and/or via other suitable visual characteristics associated with the award elements, such as background, color, animation, graphical elements, and the like. The new award elements, additional or alternatively with respect to the functionally-derived award value, may include parameters associated with the other game functions that are at least partially based on or at least partially a function of the game function parameters of the removed award element(s).

The collection sequence presented by the presentation assembly visually conveys the actions and results of the steps 106-110 to the player and any other suitable game events occurring in response to the detected collection event. The collection sequence includes animations and/or other suitable graphical updates to the bonus game interface. For example, the presentation assembly is configured to animate the removal of the award or awards associated with the collection event and animate the addition of the new award element based at least partially on the removed award or awards. The presentation assembly may animate the generation and addition of the new award element in a manner that visually conveys the relationship between the removed award and the new award.

Following the steps 106-110, the game-logic circuitry performs any remaining outcome determinations in response to the bonus game outcome of step 104, including determining whether or not the bonus game has concluded (i.e., no remaining duration), or the determination at step 112. In particular, at step 112, the game-logic circuitry determines whether or not an award event is present based on the bonus game outcome. The award event, similar to the collection event, is detected by comparing predetermined criteria associated with the award event to the current state of bonus game in response to the outcome generation. In at least some embodiments, the bonus game includes a plurality of award events that each have respective criteria to be compared to the current state of the bonus game.

The award events include at least one award event associated with the set of available awards. That is, at least one award event is available to provide an award based on the value visually indicated by one or more available awards. In response to an award event associated with the available awards, a selection process or sequence may occur to generate and present the one or more available awards associated with a detected award event. In other embodiments, the detected events and/or characteristics of the current game state that indicate an award event also determine which available awards are to be awarded (i.e., associated with the award event). For example, the award event may include the presence of a particular award symbol within the bonus game outcome, the characteristics and/or type of the award symbol indicates which available awards are associated with the award event.

If an award event is detected at the step 112, the game-logic circuitry identifies a corresponding award and causes the presentation assembly to present, at step 114, an award sequence for the award. The award sequence includes one or more animations of the bonus game interface and/or other suitable audiovisual presentations that indicate to the player that an award has been provided. In at least some embodiments, the award sequence includes visually updating at least one meter, such as a credit balance meter and/or an award meter, within the bonus game interface. The meters provide the player with a visual representation, generally as numerical values, of the current state of the game and the consequence of the current presentation sequence (e.g., the award sequence).

The award associated with the award event may be an award value shown within the bonus game interface (e.g., award indicia of an award element or a progressive jackpot award) or another suitable interface, such as a graphical table outlining the awards for outcomes including certain winning symbol combinations. Some awards may be awards at least partially based on or a function of a plurality of awards or other suitable value-based game parameters. In one example, the award may be an aggregation of a plurality of awards. In another example, historical wager parameters of the player (e.g., the value of the last wager, wager frequency, etc.) may affect the award.

In at least some embodiments, the collection event of step 106 may be an award event, where the corresponding award event is at least partially a function of the removed awards at step 108. For example, if a single available award is collected or removed from the set of the available awards, the award sequence is presented for an award matching the value visually indicated by the collected award. In another example, a plurality of available awards is collected in response to a single collection event, and the award provided within the award sequence is an aggregate of the collected awards or another suitable function of the collected awards (e.g., the highest collected award is provided, a multiplier or additional value is applied to the aggregate collected value, etc.). In certain embodiments, rather than the collection event also being an award event, the collection and award events may be discrete, linked events. That is, the collection event may cause one or more awards to be collected, and the collected awards are provided to the player as an award in response to a subsequent (or concurrent) award event. In one example, the values of the collected awards are aggregated within a meter or pot, where the aggregated value of the collected award meter is provided as an award in response to a subsequent trigger event.

Following step 114 (or in response to determining no award event is present at step 112), the game-logic circuitry resolves any remaining outcome determinations before proceeding to the next bonus game outcome or concluding the bonus game if a termination condition is detected (e.g., an allotted number of bonus game outcomes have expired).

Although the method 100 is described above with respect to a bonus game, it is to be understood that the method 100 may be adapted to function within a base game or other suitable component of an underlying game. For example, rather than transitioning to another game component, the base game including the functionality of the method 100 may include a reset condition that resets or otherwise changes the set of available awards.

In at least some embodiments, the set of available awards is arranged within an award queue. That is, the award elements are arranged according to a particular order, and corresponding game functions select, remove, award, and/or the like from the set of available awards based on the current state of the award queue.

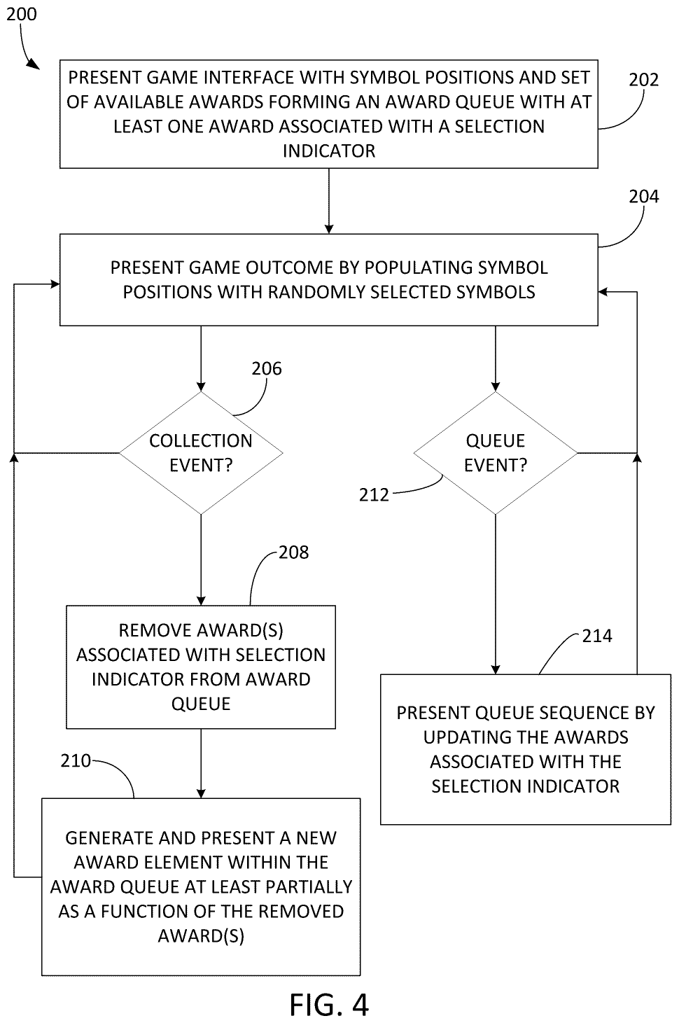

FIG. 4 depicts a flow diagram of an example method 200 for operating a gaming machine of a gaming system (e.g., the system and machine 10 of FIGS. 1 and 2). More specifically, the method 200 is associated with a game feature that includes a set of available awards arranged into an award queue. The method 200 is substantially similar to the method 100 shown in FIG. 3 unless otherwise noted. Like the method 100, the method 200 is performed by game-logic circuitry of the gaming system and a presentation assembly of the gaming machine. In other embodiments, the method 200 may be performed using additional, fewer, or alternative steps and/or via a different configuration of underlying devices, including those steps and configurations described elsewhere herein.

In the example embodiment, similar to the method 100, the method 200 is associated with a bonus game that is initiated in response to a bonus trigger event detected in a corresponding base game, such as detecting a threshold number of bonus trigger symbols within a base game outcome. Initiating the bonus game includes the presentation assembly presenting a transition sequence to transition a base game interface to a bonus game interface. More specifically, at step 202, the presentation assembly presents a bonus game interface with a plurality of symbol positions and a set of available awards arranged into an award queue. That is, the available awards are visually arranged in a manner that indicates an order or progression through the available awards. The visual arrangement may be indicated via a relative placement of award elements (e.g., left to right, top to bottom, etc.) and/or the use of additional graphical elements to facilitate recognition of the queue. In some embodiments, at least some of the available awards are hidden from the bonus game interface at a given time such that removing awards or advancing the queue causes one or more previously hidden award elements to be added to the bonus game interface. In other embodiments, the award queue is visible in its entirety within the bonus game interface.

In the example embodiment, the bonus game interface includes at least one selection indicator associated with the award queue. The selection indicator is a visual element configured to be associated with a subset of the award queue (i.e., at least one award element and less than all award elements of the queue) at a given time. For example, the selection indicator may be one or more arrows pointing towards or a highlighted border encompassing one or more award elements of the queue. The subset of available awards associated with the selection indicator is dynamic and may change through the bonus game. That is, awards may be added, removed, replaced, or otherwise changed with respect to the selection indicator. In certain embodiments, the subset may be expanded or contracted to include a different number of awards from the set of available awards. The presentation assembly is configured to present one or more animations and/or other suitable graphical changes to visually indicate the new or updated subset relative to the selection indicator. In one example, the selection indicator appears fixed within the bonus game interface, and the award elements of the set of available awards are animated to move along a path including the selection indicator. In another example, the selection indicator is animated to move to a different location on the bonus game interface relative to the set of available awards, thereby defining a new subset.

As used herein, the subset of awards associated with the one or more selection indicators at a given time is considered to be within a “selection region.” The selection region may be visually indicated as an area within the bonus game interface, and/or the selection region may be an underlying game data structure that defines the awards within the subset. For example, the selection region may be an array storing award identifiers for each of the award elements within the subset. In another example, each award element is a defined by a plurality of stored variables, and the selection region is defined by a flag or other suitable variable indicating whether or not each award element is currently within the subset.

At step 204, the game-logic circuitry generates a bonus game outcome and causes the presentation assembly to animate an outcome sequence to present the bonus game outcome by selectively populating the symbol positions of the bonus game interface with randomly selected symbols from one or more sets of available symbols for the bonus game. In one example, the presentation assembly presents a spinning animation for one or more symbol-bearing reel strips associated with the symbol positions and stopping the reel strips on the symbols within the generated bonus game outcome. Other suitable animations for presenting the randomly selected symbols of the bonus game outcome may be used, including those without the use of symbol-bearing reel strips.

Following the generation of the bonus game outcome, the game-logic circuitry is configured to one or more outcome determinations based on the current state of the bonus game. Steps 206 and 212 are example determinations as described herein, and it is to be understood that additional or alternative outcome determinations may be performed for a given bonus game outcome. For example, the game-logic circuitry may evaluate the symbols occupying symbol positions to determine whether or not a winning symbol combination or a jackpot award trigger are present.

At step 206, the game-logic circuitry determines whether or not a collection event has occurred based on the bonus game outcome, similar to the step 106 shown in FIG. 3. The collection event may include, for example and without limitation, detecting a collection symbol within the randomly selected symbols of the bonus game outcome. If no collection event is detected, the game-logic circuitry concludes any remaining outcome determinations before either concluding the bonus game (in response to detecting a termination condition for the bonus game) or continuing to the next bonus game outcome at step 204. However, if a collection event is detected, the method 200 proceeds to step 208.

At step 208, the game-logic circuitry causes the presentation assembly to present an animation for removing one or more awards from the selection region as indicated by the at least one selection indicator. In some embodiments, the next available award in the selection region is removed in response to the collection event. In other embodiments, all of the awards within the selection region are removed in response to the collection event. In further embodiments, multiple types of collection events are available, and the number of removed awards is based on the type of collection event and/or other characteristics of the collection event. In one example, the symbols available for the bonus game include a first collection symbol that causes one award of the selection region to be removed and a second collection symbol that causes all awards of the selection region to be removed. In another example, the bonus game includes a single type of collection symbol, and the number of removed awards is based on the number of collection symbols detected within one or more bonus game outcomes.

In at least some embodiments, similar to the method 100, at least one award is provided at least partially as a function of the removed awards. In one example, in response to the step 208, the presentation assembly is configured to present an award sequence for an award including the aggregate value of the one or more removed awards. In another example, the value of the removed awards is applied to a meter or pot and can be awarded in response to a separate award trigger event. In a further example, the highest award value of the removed awards is provided within an award sequence. Other suitable mathematical and/or logical operations and gameplay configurations may be used in other embodiments based on the removed awards.

In at least some embodiments, removing the awards from the award queue also includes one or more animations to update the selection region to include a new subset from the award queue. For example, the award elements are removed from the award queue, other award elements outside of the selection region may be animated to advance into the selection region, or the selection indicators are animated to advance to a new selection region. In certain embodiments, updating the selection region may occur in response to a separate trigger event such that the selection region remains associated with empty positions or inactive award elements left from the removed awards. As described herein, these positions may also be filled by new award elements added to the set of available awards.

At step 210, in response to removing the one or more awards at step 208, the game-logic circuitry generates at least one new award element to be added to the set of available awards and causes the presentation assembly to present one or more animations to visually indicate the new awards within the award queue. In the example embodiment, the new award elements are generated with an award value at least partially as a function of the removed award or awards at step 208. For example, if a single award is removed, then a new award element is added at a different position of the award queue with the same award value. In another example, if multiple awards are removed, the new award element may include an aggregate value of the removed awards or have an award value having a different functional relationship to the removed awards. In certain embodiments, the new award element may include award indicia for each of the removed awards such that subsequent removal of the new award element results in a selection process in which one of the values indicated by the award indicia is selected and provided as an award. Generating new award elements in response to removing or awarding award elements ensures that the set of available awards maintains a certain number of awards for the presentation of the bonus game interface and, by creating new awards based on previously removed awards, the player is provided an opportunity for exciting, progressive awards. Moreover, such awards are generated, removed, and awarded through a unique presentation with readily understood award indicia and streamlined underlying game processes relative to standard symbol wagering game processes (e.g., comparing various symbol combinations to the current game state and determining any corresponding awards) that facilitate improved computing resource efficiency.

In some embodiments, the new award elements are added at the same relative position within the award queue as the removed award elements. In other embodiments, the new award elements are added at a random or partially random position within the award queue. In one example, the game-logic circuitry is configured to ensure any new award elements are added at a random queue position external to the selection region. In certain embodiments, the queue position of a new award element may be at least partially based on the award value of the new award element. For example, higher-valued award elements may be biased (e.g., via weight parameters applied to one or more random values) to have a random position further away from the selection region relative to the average random position of a lower-valued award element. In other embodiments, the position of new award elements may be predetermined or assigned based on nonrandom parameters. The presentation assembly is configured to present one or more animations for the new award element, including animations that shift other preexisting award elements within the bonus game interface to reflect the updated award queue.

In some embodiments, the step 210 may be performed for certain collection events. That is, some collection events and award removals may not result in new award elements being added to the award queue, or at least new award elements at least partially as a function of the removed awards. In one example, new award elements may be added irrespective of the removed awards for particular collection events, such as collection events resulting in a single removed award. In another example, some awards may not result in new award elements, such as progressive jackpot awards. Additionally or alternatively, new award elements may be added to the set of available awards without connection to any removed award. For example, if the set of available awards is not cyclical (i.e., awards can be removed without being collected to make space for new awards), new award elements may be generated according to stored parameters and variables by the game-logic circuitry.

Following the new award element addition at step 210, the game-logic circuitry performs any remaining outcome determinations, such as the step 212, for the bonus game outcome and then either concludes the bonus game in response to a detected termination condition or continues with a subsequent bonus game outcome at step 204.

At step 212, the game-logic circuitry determines whether or not the bonus game outcome includes a queue event. The queue event is a game event that triggers a change to the award queue, and in particular, to the selection region associated with the award queue. The queue event may be detected as the presence and/or absence of certain events, parameters, conditions, and the like with respect to the bonus game outcome. In the example embodiment, the collection events and subsequent actions (i.e., steps 208 and 210) are a queue event that causes the selection region to be changed. In some embodiments, each bonus game outcome triggers a queue event such that the selection region changes every bonus game outcome irrespective of any awarded or removed awards at step 208.

At step 214, the presentation assembly presents a queue sequence by updating the awards associated with the selection indicator. It is to be understood that “updating the awards associated with the selection indicator” may include animations and/or other suitable visual updates to the awards within the selection region, the selection indicator relative to the award queue, and the like. For embodiments with multiple selection indicators (e.g., selection indicators for the beginning and end of a selection region, or selection indicators for different selection subregions), all or some of the selection indicators and/or the respective award elements may be updated. In some embodiments, after each bonus game outcome, one, some or all of the award elements within the selection region are replaced with the next award elements within the award queue such that the award queue is dynamic throughout the bonus game. In certain embodiments, the number of award elements replaced in response to a given queue event may vary depending upon random change, the type of queue event, the events, conditions, and/or other parameters of the detected queue event, and/or player input. For example, the entire selection region may be replaced in response to a bonus game outcome without any collection events, while bonus game outcomes with collection events may advance the number of positions needed to replace the collected award elements at step 208.

As stated above, the selection indicators and/or the award elements of the award queue are animated, via the presentation assembly, to visually indicate the changes or updates to the award queue and the associated selection region. That is, the selection indicator and the award elements of the award queue that are within the updated selection region are visually linked to each other (e.g., positioned adjacent to each other or in an at least partially overlapping configuration). Other suitable changes to the bonus game interface may occur in response to the queue sequence, such as adding previously hidden award elements from the award queue to the bonus game interface and removing the replaced award elements from the prior selection region from the bonus game interface.

Following the queue sequence, the game-logic circuitry completes any remaining outcome determinations before transitioning to the next bonus game outcome or the conclusion of the bonus game in response to any detected termination condition.

In some embodiments, the awards within the award queue may not be limited to credit-based awards, but rather include additional or alternative awards, game modifiers, and the like. That is, in one example, a modifier may be within the award queue that, when collected or removed, applies the modifier to the bonus game, which may include modifying other award elements, symbols within the symbol positions, and/or provided awards. Modifiers for the award queue may be, additionally or alternatively, available within the available symbols of the bonus game, where detecting a modifier symbol or other suitable modifier trigger event causes a modifier sequence to be presented by the presentation assembly, where a modifier is applied to one or more awards within the award queue via one or more animations.

FIGS. 5A-5H depict an example game interface 300 for a game feature according to one or more embodiments of the present disclosure. The game interface 300 is presented via a presentation assembly of a gaming machine within a gaming system (e.g., the system and machine 10 shown in FIGS. 1 and 2). The game interface 300 may be presented via a single electronic display device or a plurality of display devices of the presentation assembly. The presentation assembly is configured to animate or otherwise update the game interface 300 according to game processes executed by game-logic circuitry, which may be at least partially integrated with the gaming machine or another suitable device in communication with the gaming machine (i.e., for embodiments with a thin client gaming machine).

In the example embodiment, FIG. 5A depicts the game interface 300 in a first state. The game interface 300 includes a plurality of symbol positions arranged into a symbol array 302, a credit meter 304, a bet or wager meter 306, an award meter 308, and a plurality of available awards 310. In other embodiments, the game interface 300 includes additional, fewer, or alternative game and/or presentation elements, including those described elsewhere herein. In one example, the game interface 300 is associated with a bonus game, and the game interface 300 includes a duration counter that visually indicates the remaining duration of the bonus game to the player.

The symbol array 302 includes three rows and five columns of symbol positions. In other embodiments, the symbol array 302 may be arranged into a different configuration having the same, more, or less symbol positions. In certain embodiments, the interface 300 may include a plurality of symbol arrays. The symbol array 302 is configured to be selectively occupied by symbols within game outcomes. The symbols are selected at least partially at random from one or more sets of available symbols associated with the game of the game interface 300. Each set of available symbols is associated with at least one symbol position of the array 302. In one example, each symbol position has a respective set of available symbols. In another example, each column has a respective set of available symbols. The symbols within one or more sets (including all sets) may be adjustable based on the events, conditions, or other aspects of the current game state. In some embodiments, the sets of available symbols are symbol-bearing reel strips that are animated to spin and stop to present symbols within the corresponding symbol position or positions.

The credit meter 304 visually represents the current credit balance of the player, the bet meter 306 depicts the player's current or last wager, and the award meter 308 visually indicates the last or current award. Each of the meters 304, 306, 308 are animated or visually updated by the presentation assembly to visually indicate any changes to the associated amount, thereby providing the player with a direct manner to track progression of the underlying wagering game. For embodiments associated with non-wagering games, additional, fewer, or alternative meters may be used. For example, some non-wagering games may include a timer that indicates any remaining duration of an allotted playtime for the gaming session.

The set of available awards 310 includes a plurality of award elements 312 arranged into an award queue. Each award element 312 includes indicia visually indicating a corresponding award and/or other suitable game effect, such as a modifier or a bonus trigger. In the illustrated embodiment, the set of available awards 310 includes credit awards and a progressive jackpot award (i.e., identified by the ‘MINI’ indicia). In some embodiments, one or more award elements 312 may include indicia depicting a plurality of award values. The indicia may be visible throughout play of the game associated with the game interface 300, or the indicia may be at least partially hidden or otherwise dynamic throughout gameplay. In one example, the indicia is revealed when an award element 312 is awarded as described herein. In another example, the indicia may include multiple possible values (e.g., a reel strip, award wheel, etc.), and one of the values may be selected prior to or while the award element 312 is awarded.

In the example embodiment, the set of available awards 310 has a river-like appearance that visually indicates an order among the award elements 312 (i.e., from top to bottom, with the bottommost award elements being at the beginning of the queue). In other embodiments, other suitable visual configurations of the award elements 312 may be used, including configurations without an award queue. The presentation assembly is configured to present an animation that further indicates the order of the award queue, such as the award elements 312 ‘flowing’ or moving downwards from the top of the game interface 300 towards (and, in some embodiments, past) the beginning of the queue. In some embodiments, the award elements 312 entering the award queue at the top of the game interface 300 are new award elements 312 added to the award queue. In other embodiments, the award elements 312 are prior elements 312 from the queue (i.e., the queue is cyclical, where elements 312 from the beginning of the queue return to the end of the queue). In further embodiments (including the example embodiment), the set of the available awards 310 includes more award elements 312 than can be displayed with the game interface 300 at a given time, and therefore a portion of the set of available awards 310 is hidden from view in the first state. The hidden portion may be the end of the award queue, or at least the portion of the award queue furthest away from being selected as described herein.

The game interface 300 also includes a selection region 314 associated with the set of available awards 310. The selection region 314 encapsulates one or more award elements 312 from the set of available awards 310 for potential selection, removal, and/or award as described herein. In the example embodiment, the selection region 314 is depicted as a border around three of the award elements 312. In other embodiments, other suitable visual depictions of the selection region may be used, including visual changes to the award elements and/or other suitable game elements. In certain embodiments, the region itself may not be visually explicit, but rather one or more presentation elements are configured to implicitly define the region within the set of available awards 310. In one example, the game interface 300 includes a selection indicator that points towards one or more award elements 312 in the selection region. In another example, the award elements 312 within the selection region may change color and/or other presentation aspects when transitioning into or out of the selection region.

The selection region 314 is defined at the beginning of the award queue. That is, the award elements 312 are animated to travel down from the top of the game interface 300 towards and into the selection region 314. As described herein, the selection region 314 provides a visual indication of the one or more award elements 312 associated with a particular game event. The award elements 312 within the selection region 314 may be configured to stay until an even associated with the award elements 312 occurs, or the award elements 312 may be animated to leave the selection region 314 in the absence of a game event within a predefined duration. In one example, after every game outcome or spin, the presentation assembly animates the set of available awards to update the queue (e.g., move the award elements 312 through the queue), thereby including at least one new award element 312 within the selection region for the next game outcome.

FIG. 5B depicts the game interface 300 in a second state including a game outcome. The second state follows the game-logic circuitry generating the game outcome (e.g., by generating one or more random values and comparing the random values to one or more weighted tables of the available symbols or reel stop positions stored by the game-logic circuitry to select symbols defining the game outcome) and the presentation assembly presenting at least a portion of an outcome sequence. The outcome sequence is a set of animations, visual updates, and/or other suitable outputs from the presentation assembly (including audio, visual, tactile, etc. outputs) associated with the game interface 300 that convey that a new game outcome has occurred. The outcome sequence may also include certain presentations associated with outcome determinations performed by the game-logic circuitry after generating the game outcome.

In some embodiments (including the example embodiment), the symbol array 302 may not be filled in its entirety with randomly selected symbols for a given game outcome. That is, some symbol positions may be filled with a ‘blank,’ which may be selected in a similar manner as symbols from the set of available symbols. In certain embodiments, the symbol positions may be filled or occupied by inactive symbols that do not contribute to the game outcome. The inactive symbols may be visually distinct from active symbols (e.g., partially transparent, greyed out, etc.) for the player to readily understand which symbols do not contribute to the game outcome. In other embodiments, every symbol position of the array 302 is occupied by a symbol and contributes for each game outcome.

In the example embodiment, the symbols occupying the array 302 within FIGS. 5A-5H are limited to the symbols to depict the functionality described herein. It is to be understood that the blank symbols may be blank, filled with inactive symbols, filled with active symbols, or otherwise used to provide functionality beyond those described herein.

In the second state, the game outcome includes a collection symbol 316. The collection symbol 316 is configured to trigger a collection event associated with the set of available awards 310. In certain embodiments, in addition to the collection event functionality described herein, the collection symbol 316 may be associated with other game functionality, such as determining winning symbol combinations, triggering additional game features, and the like. In the example embodiment, the collection symbol 316 is visually distinguished from other symbols by the ‘C’ indicia within the symbol 316. It is to be understood that the collection symbol 316 may be visually distinguished from other symbols (including other types of collection symbols) using additional and/or alternative characteristics.

FIG. 5C depicts the game interface 300 in a third state following the second state. In the third state, the collection event associated with the collection symbols 316 is active, and the presentation assembly is presenting a collection sequence for the symbol 316. In particular, the next award value from the award queue (i.e., the award value of ‘500’ shown in the selection region 314 of FIG. 5B) is selected and collected by the collection symbol 316. The indicia of the collection symbol 316 is updated to include the collected value, and the collected value is removed from the selection region 314 of the set of available awards 310. In some embodiments, the remaining award elements 312 may be animated to shift or otherwise change position within the interface 300 to reflect a new state of the award queue. For example, the selection region 314 is updated to include values of ‘400,’ ‘250,’ and ‘100’ from left to right. In other embodiments, the remaining award elements 312 may remain in the same position (thereby leaving a gap or other presentation element in the space previously occupied by the collected award element 312) until a subsequent game outcome occurs, at which point the award elements 312 shift as described above.

The visual update to the award queue may include revealing one or more hidden award values from the set of available awards and/or introducing a new award element to the award queue having an award value at least partially based on the value of the collected or removed award element. In one example, the new award element has an award value equal to the collected award element. In another example, the new award element may have an award value greater than the collected award value, thereby increasing the value of the available award elements 312. In a further example, a previously hidden award from the set of available awards 310 is added to the interface 300 in response to the award elements 312 of the award queue shifting (e.g., award element 318 shown in FIG. 5D following the update to the award queue). In other embodiments, other suitable collection sequences having additional, fewer, or alternative animations, visual updates, and/or other presentation outputs adapted to the particular configuration of the underlying game may be used.

In at least some embodiments, the collection symbol 316 is awarded in response to the collection event. That is, the award value applied to the collection symbol 316 is subsequently awarded to the player within an award sequence. In certain embodiments, the collection symbol 316 may be held within the symbol array 302 until the conclusion of the game such that the presentation assembly presents an award sequence for all held value-bearing symbols in the array 302.

In some embodiments, the collection sequence includes adding one or more new award elements 312 to the set of available awards 310. The award elements 312 may be adjusted within the award queue to adapt to the new award elements 312. In other embodiments, the collection sequence does not include adding any new award elements to the award queue. In certain embodiments, the addition of award elements 312 to the set of available awards 310 is not directly tied to collection events. For example, the set of available awards 310 may be required to include at least a predefined minimum number of awards. In this example, the game-logic circuitry compares the number of award elements 312 after each removal to the predefined minimum to determine whether or not one or more new award elements 312 should be generated and added to the set of available awards 310. An example of the award element addition to the award queue is described herein.

FIG. 5D depicts the game interface 300 in a fourth state following the third state. In the fourth state, a subsequent game outcome is presented. More specifically, the symbol array 302 is selectively populated with an aggregate collection symbol 320. The aggregate collection symbol 320 is a different type of collection symbol relative to the collection symbol 316 shown in FIGS. 5B and 5C, though the aggregate collection symbol 320 may include the same or similar functionality as the collection symbol 316 unless otherwise noted herein. In other embodiments, the aggregate collection symbol 320 is the same type of collection symbol as the symbol 316. In such embodiments, other suitable game conditions, events, and/or parameters dictate the differing functionality between the symbols 316, 320, such as and without limitation, the position of the symbols 316, 320 within the array 302, the current state of the set of available awards 310, a catalyst symbol within the array 302, one or more random values, and/or the like. The aggregate collection symbol 320 may include visual characteristics that differ from the collection symbol 316, thereby providing the player clear visual distinction between collection symbol types. In other embodiments, the collection symbols may at least initially appear similar or the same to other types of collection symbols.

In the example embodiment, the game-logic circuitry is configured to determine a collection event is present within the game outcome of the fourth state in response to detecting the presence of the aggregate collection symbol 320 within the array 302. In other embodiments, additional or alternative conditions and parameters may be used to determine whether or not the collection event is active, such as a random determination or detecting a plurality of collection symbols within the array 302.

In response to the collection event being detected, a collection sequence is presented. In contrast to the collection sequence for the collection symbol 316, which collected a single award element 312 from the selection region 314, the collection sequence for the symbol 320 includes collecting a plurality of award elements 312. In the example embodiment, the collection sequence for an aggregate collection symbol such as the symbol 320 includes collecting all of the award elements 312 within the selection region 314. In other embodiments, the aggregate collection symbol 320 collects additional, fewer, or alternative award elements 312 from the award queue. In one example, the number of collected award elements 312 is dynamic and may be at least partially random. In another example, the aggregate collection symbol 320 may initially include indicia visually indicating how many award elements 312 are to be collected. In certain embodiments, the collected award elements 312 are not limited to the selection region 314, but rather may include other elements from the set of awards 310. For example, the award queue may not have a selection region 314, or the set of available awards 310 may not be arranged into an award queue.

The collection sequence includes one or more animations visually depicting the collection or otherwise link between the collection symbol 320 and the collected award elements 312. In one example, the collected award elements 312 are animated to move towards the collection symbols 320. The collection symbol 320 is visually updated to include award indicia for an aggregate award from the collected award elements 312 as described in detail below. In other embodiments, the collection sequence may include additional or alternative animations and/or other suitable presentation outputs to depict the underlying game functionality. Moreover, although the aggregate collection symbol 320 is described as aggregating or combining the award values of the collected award elements 312, it is to be understood that other suitable logical and/or mathematical operations may be performed to generate an award value for the symbol 320 that is at least partially a function of the award values of the collected award elements 312. In certain embodiments, the other logical and/or mathematical operations may be used by other types of collection symbols, such as a collection symbol that is updated with the highest individual award value from the collected award elements 312.

FIG. 5E depicts the game interface 300 in a fifth state following the fourth state. In the fifth state, the collection sequence from the fourth state continues with the aggregate collection symbol 320 being updated with an aggregate award value (i.e., the value of ‘750’ shown on the award indicia of the symbol 320). In at least some embodiments, the collection sequence further includes an award sequence for providing the award value of the collection symbol 320. In certain embodiments, the aggregate collection symbol 320 is held within the array 302 until the conclusion of the game or another suitable award trigger event is detected. In other embodiments, the collection event may not directly result in an award sequence for the symbol 320, but rather a separate, independent award trigger event is required to prompt the award sequence.

In addition to the update to the aggregate collection symbol 320, the game-logic circuitry is configured to cause the presentation assembly to add a new award element 322 to the set of available awards 310 at least partially as a function of the collected award values. In the example embodiment, the new award element 322 includes an award value equal to the collected award value, thereby matching the value of the aggregate collection symbol 320. In other embodiments, the new award element 322 may use additional or alternative mathematical and/or logical operations to generate the new award element 322, such as selecting the highest individual collected award value or select an award value from a range of values with a median value equal to the collected award values. In certain embodiments, for one or more types of collection symbols, the new award element 322 may have a value untethered to the collected award value, include additional or alternative awards (e.g., free spins, modifiers, jackpot triggers, etc.), and/or is initially hidden from the game interface 300 (i.e., is added to the award queue at a position that is not presented via the interface 300). In further embodiments, the collection sequence may include adding a plurality of new award elements to the set of available awards 310, where each of the new award elements may include an award value generated using the same, different, or similar functional operations relative to each other.

FIG. 5F depicts the game interface in a sixth state following the fifth state. In the sixth state, the award queue has been updated to include the new award element 322. More specifically, in the illustrated embodiment, the award elements 312 behind (i.e., further from the selection region 314) the position occupied by the new award element 322 are updated to shift back one position within the award queue. In some embodiments, the position of the new award element 322 is known by the game-logic circuitry prior to the collection sequence, and the award elements 312 are animated accordingly. For example, during the collection sequence, the award elements 312 ahead of the position of the new award element 322 shift forward within the award queue in response to the removal of the one or more collected award elements while the award elements 312 behind the position of the new award element 322 remain fixed in place, thereby leaving a void or empty position for the new award element 322 to occupy. It is to be understood that the collection sequence may include other suitable animation choreography according to the particular theme and/or configuration of the game interface 300 and the underlying game. In other embodiments, rather than adding the new award element 322 between existing award elements 312, the new award element 322 may replace one or more award elements 312 within the award queue.

In at least some embodiments, the position of the new award element 322 within the award queue is at least partially random. In one example, any position within the award queue is available to be populated by the new award element 322. In another example, any visible position in the game interface 300 is available to receive the new award element 322. In a further example, the new award element may be added to any visible position within the award queue that is external to the selection region 314. One or more random values or other variables are used by the game-logic circuitry to determine where to place the new award element 322. In certain embodiments, the random determination for positioning the new award element 322 is weighted (e.g., by applying weight parameters to a mathematical and/or logical operation performed by the game-logic circuitry for the position determination) to affect the probability of the new award element 322 favoring certain positions within the award queue. In other embodiments, the position of the new award element 322 may be predetermined or based on non-random determinations. In one example, the award value of the new award element 322 is compared to a plurality of predefined threshold values and the position of the new award element 322 is selected from a predefined set of positions based on the comparison.

FIG. 5G depicts the game interface 300 in a seventh state following the sixth state. In the seventh state, a subsequent game outcome is shown including a collection symbol 324 occupying the symbol array 302 and a dynamic award element 326 in a lead position with the selection region 314 of the award queue. The dynamic award element 326 is an award element with award indicia that changes or is revealed in response to certain game events, such as a collection event associated with the dynamic award element 326. In the illustrated embodiment, the dynamic award element 326 includes award indicia for three separate award values. In other embodiments, the dynamic award element 326 includes indicia for additional, fewer, or alternative awards, including non-credit awards. In further embodiments, the dynamic award element 326 may depict the variable or hidden award value through other presentation configurations, such as a award value-bearing reel strip within the element 326 or visually obscuring the award indicia with an intermediate graphical element.

In response to a corresponding game event, such as a collection event associated with the element 326 in the example embodiment, the presentation assembly is configured to present a selection sequence for the dynamic award element 326 that selects or otherwise presents an award value representing the dynamic award element 326. For example, the dynamic award element 326 may be configured to spin or an associated spin indicator is animated to spin around the element 326 before landing on or pointing to one of the visually indicated awards. In certain embodiments, additional values may be selected, such as values based on the plurality of award values presented by the dynamic award element 326. In one example, an aggregate value of all values presented by the element 326 may be selected.

FIG. 5H depicts the game interface 300 in an eighth state following the seventh state. In the eighth state, a collection sequence for the collection symbol 324 is occurring. More specifically, a value of ‘800’ is selected for the dynamic award element 326, and the collection symbol 324 collects the value from the dynamic award element 326 via updating the award indicia of the collection symbol 324. Subsequent to the eighth state, the dynamic award element 326 is removed from the award queue and the game interface 300.

FIGS. 5A-5H depict the game interface through states in which one or more game events associated with the set of available awards 310 has occurred. If no game event is detected in a game outcome (or over a plurality of game outcomes), the set of available awards 310 may still be configured to update. In the example embodiment, if no collection or award event occurs in a given game outcome, the award queue is updated by the presentation assembly removing one or more award elements 312 from the selection region and shifting the remaining elements 312 forward within the queue, which may expose one or more previously hidden award elements at the end or back of the award queue relative to the interface 300. In other embodiments, the award queue remains static until a corresponding game event occurs. In certain embodiments, the award queue is updated randomly or in response to another suitable game event, such as a particular update symbol occupying the symbol array 302.

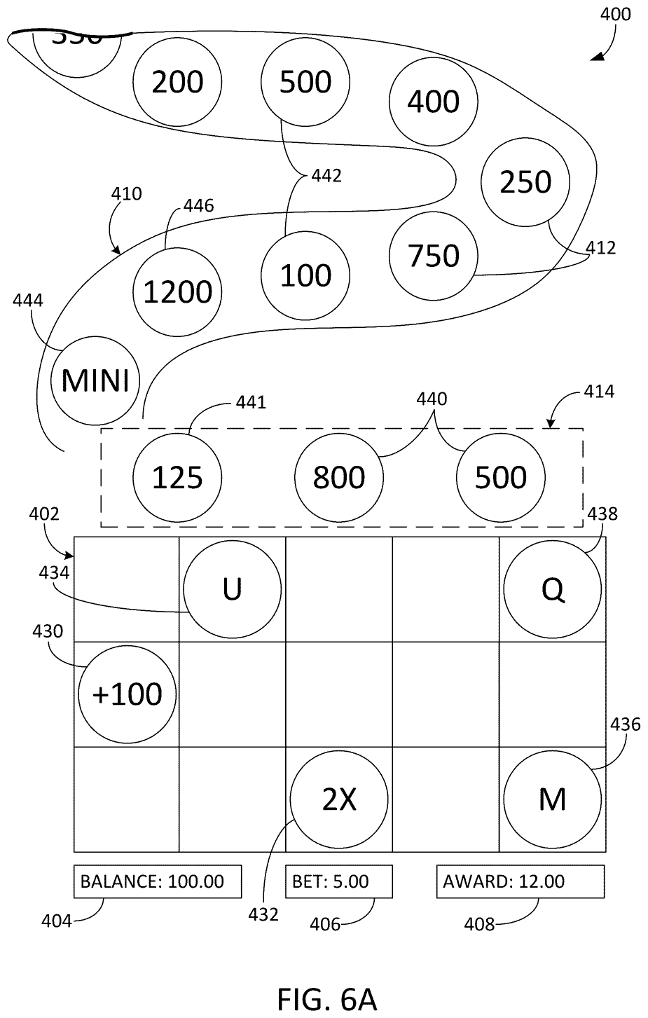

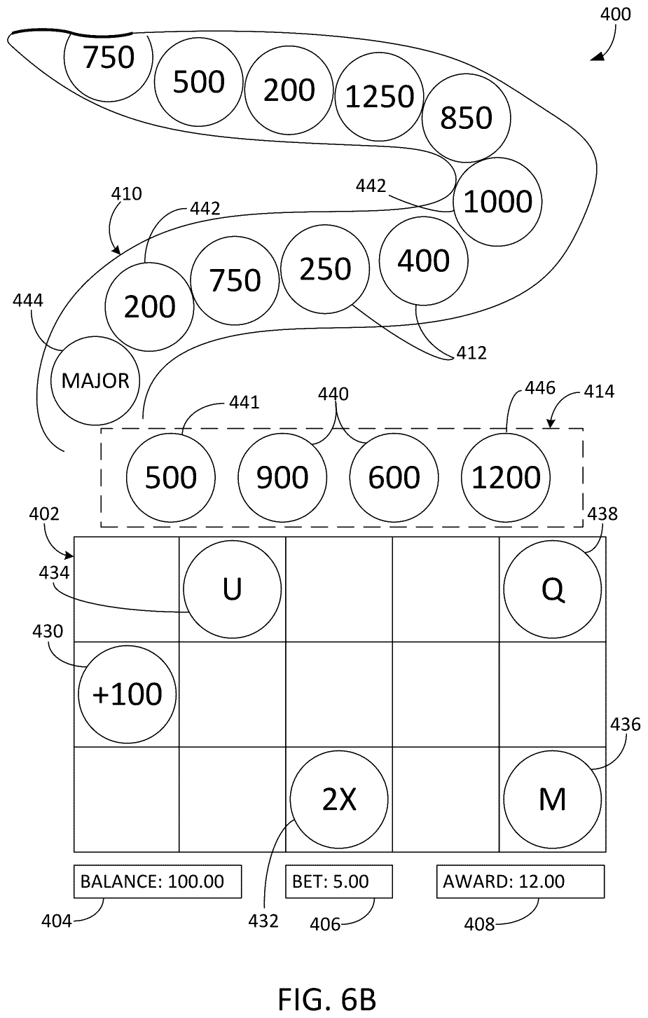

FIGS. 6A and 6B depict a game interface 400 of a gaming system for a game similar to the game associated with the game interface 300 shown in FIGS. 5A-5H. The game interface 400 may be presented via a presentation assembly of a gaming machine within the gaming system (e.g., the machine 10 and system shown in FIGS. 1 and 2) in communication with game-logic circuitry to provide the functionality described herein. The game interface 400 depicts several additional or alternative game functionality in relation to a set of available awards. In the example embodiment, the game interface 400 includes the same or similar presentation elements as the game interface 300 unless otherwise noted. More specifically, the game interface 400 includes a symbol array 402, a credit meter 404, a bet meter 406, an award meter 408, and a set of available awards 410. The set of available awards 410 includes a plurality of award elements 412 and includes a selection region 414. In other embodiments, the game interface 400 includes additional, fewer, or alternative game and/or presentation elements, including elements described elsewhere herein.

With respect to FIG. 6A, the game interface 400 is depicted in a first state in which a game outcome has been presented. The game outcome includes populating the symbol array 402 with several modifier and/or special symbols associated with the set of available awards 410. More specifically, the game outcome includes a credit symbol 430, a multiplier symbol 432, an upgrade symbol 434, a mover symbol 436, and a queue symbol 438. Similar to the game interface 300 within FIGS. 5A-5H, it is to be understood that other symbols—active or inactive—may further populate any remaining empty positions of the symbol array 402, such as collection symbols, value-bearing symbols, and the like. Other suitable modifier and/or special symbols beyond those shown in FIGS. 6A and 6B are contemplated within the spirit and scope of the present disclosure, particularly in relation changing the award queue and/or updating the values of the award elements 412 within the award queue.

In the example embodiment, the symbols 430-438 are associated with one or more award elements 412 from the set of available awards 410. The association is visually depicted via one or more linked animations, visual characteristics, and/or other suitable visual indicators presented by the presentation assembly. The link between a given symbol and one or more award elements 412 may be predetermined or dynamic, such as a random selection of the award element(s) 412 from the award queue. In the example embodiment, the credit symbol 430 is associated with the award elements 440, the multiplier symbol 432 is associated with the award elements 442, the upgrade symbol 434 is associated with the award element 444, and the mover symbol 436 is associated with the award element 446 of the set of available awards 410. In at least some embodiments, one award element 412 may be associated with a plurality of modifier or special symbols, such as the award element 441 that is associated with both the credit symbol 430 and the multiplier symbol 432.

In the example embodiment, the symbols 430-438 are associated with respective game events and corresponding presentation sequences that cause one or more changes to the set of available awards 410 as described herein. For illustrative purposes, the game events require a single symbol of a given symbol type to trigger the corresponding presentation sequence and game action(s). In other embodiments, each symbol may require additional symbols or other suitable game events and/or conditions to trigger the corresponding presentation sequence and game action(s).

FIG. 6B depicts the game interface 400 in a second state following the first state shown in FIG. 6A. In the second state, the presentation assembly has applied the effects of the symbols 430-438 to the set of available awards. The credit symbol 430 caused the award elements 440, 441 to be increased by the indicated value (i.e., 100 credits), which includes visually updating the award indicia of the award elements 440, 441. The indicated value of the credit symbol 430 may be random, partially random, or based on one or more predefined parameters, such as the wager level of the player or a static, predefined value. In certain embodiments, the value indicated by the credit symbol 430 may be at least initially hidden. In one example, the added value is revealed prior to being applied to the award elements 440, 441. In another example, the value is not visually indicated within the credit symbol 430, but rather is shown elsewhere within the interface 400 or is implicitly revealed based on the change to the award elements 440, 441.

The multiplier symbol 432 causes a multiplier (i.e., a 2× multiplier) to be applied to the corresponding award elements 441, 442. In response to the multiplier being applied to the award elements 441, 442, the award indicia of the award elements 441, 442 are updated. Other suitable multipliers may be used, including embodiments in which each award element 412 associated with a given multiplier symbol may receive a different multiplier.

In the example embodiment, the award element 441 is subject to two modifications from the credit and multiplier symbols 430, 432. The award value of the award element 441 is first increased in response to the credit symbol 430 and then multiplied by the multiplier of the multiplier symbol 432. The game-logic circuitry is configured to store a predefined order of operations to ensure the changes to the award elements 412 reflect an intended choreography of the game. In other embodiments, the award elements 412 may only be affected by one modifier and/or special symbol for a given game outcome.

The upgrade symbol 434, similar to the credit and multiplier symbols 430, 432, changes the value of one or more award elements 412. That is, the award elements may include award values classified into a plurality of award levels or tiers, and the upgrade symbol 434 causes a corresponding award element to be updated to a value from a higher award level. In the illustrated embodiment, the corresponding award element 444 has an award value of a progressive jackpot award (i.e., a ‘MINI’ progressive jackpot as shown in FIG. 6A), and the award is upgraded to a relatively higher valued progressive jackpot (i.e., a ‘MAJOR’ progressive jackpot as shown in FIG. 6B). In this example, the upgrade is not limited to increasing the award level by a single level (e.g., from MINI to MINOR progressive jackpot), but rather the upgrade may be at least partially random. In some examples, the extent of the upgrade may be a weighted random selection. In other examples, the upgrade is limited to the next predefined value or award level. In some embodiments, the upgrade symbol 434 is limited to award elements 412 having progressive jackpot awards. In other embodiments, the credit awards or other suitable awards indicated by other award elements 412 may be eligible to be upgraded. In one example, an award element 412 with a credit award value may be upgraded to a progressive jackpot award in response to the upgrade symbol 434.

The mover symbol 436 is configured to cause the award queue to be reorganized or otherwise updated. In the example embodiment, the mover symbol 436 causes the award element 446 to advance to the beginning of the award queue, thereby expediting the award element 446 for potential collection. The other award elements 412 are updated to reflect the change to the award queue. In other embodiments, other suitable changes to the award queue may be performed in response to the mover symbol 436, such as removing award elements 412 from the award queue, shuffling the order of the award elements 412 within the queue, replacing lower valued award elements 412 with relatively higher valued award elements 412, and/or the like. In certain embodiments, the mover symbol 436 may initiate a collection event for a particular award element 412 irrespective of the position of the element 412 within the award queue.

The queue symbol 438 is configured to change the number of award elements 412 visible within the award queue on the interface 400. In the example embodiment, rather than changing the order of the award queue or changing the value of the award elements 412, the queue symbol 438 causes additional award elements 412 to be presented within the award queue. The additional award elements 412 may provide an enhanced and exciting presentation for the player, and the additional award elements 412 may provide additional opportunities to affect the award values within the award queue, such as the changes described above with respect to FIGS. 5A-6B. Additionally, in the example embodiment, the selection region 414 is increased to include an additional award element 412 from the award queue, thereby increasing the potential value of aggregate collection events. In other embodiments, the selection region 414 may stay the same and/or other changes to the award queue may be applied in response to the queue symbol. In one example, one or more award elements 412 are removed or otherwise hidden from the award queue without replacement, thereby resulting in a smaller award queue. In another example, one or more award elements 412 are condensed or aggregated together to create higher valued award elements 412 within the queue (similar to the aggregate collection event described in FIGS. 5D-5F). In a further example, the award queue is at least partially reorganized in response to the queue symbol 438. In certain embodiments, the effect of the queue symbol 438 may be triggered by a random determination rather than detecting a queue symbol 438, thereby creating a variable, dynamic, and exciting game presentation for the player.

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

In the embodiments disclosed herein, each value-bearing symbol may be assigned a credit value that is displayed upon the symbol. The credit value may, for example, range from a minimum credit value to a maximum credit value and be based on the total amount wagered on the game. For example, if a player wagers a minimum of 100 credits, the assigned credit value may range from 100 to 1000 credits. And if a player wagers a maximum of 500 credits, the assigned credit value may proportionately increase and thereby range from 500 to 5000 credits. In some embodiments, the assigned value may be randomly selected from a list of possible multipliers of the total amount wagered on the game, for example, 1×, 2×, 3×, 4×, 5×, 10×, 15×, 20×, 50×, and 100×. In other embodiments, the value may be pre-assigned to each value-bearing symbol as part of the reel strip layouts of the game reels. In still other embodiments, the assigned value may be randomly selected before, during, or at the conclusion of a reel spin.

As disclosed in the embodiments herein, awards may be provided for each game outcome based on at least the symbols currently occupying the symbol positions. For example, line pays and scatter pays may be awarded for each game cycle outcome based on the symbols populating a symbol array. In some embodiments, the value-bearing symbols may not be associated with awards outside of the features described herein. In other embodiments, the value-bearing symbols may be included within line pays, scatter pays, and/or other suitable awards. For example, the value-bearing symbols may be treated as a special symbol, such as a wild symbol.

While the embodiments are largely described within the context of a base game, it is equally contemplated that the disclosed embodiments can be practiced within the context of a free game bonus without a wager between free game cycles.

The embodiments of the present invention provide an innovative procedure for generating new awards based on preexisting or collected awards. Game-logic circuitry executing instructions in accordance with the embodiments present a visual display of spinning reels and a set of available awards with clearly enumerated symbology that combine in readily understood arrangements to provide awards and generate new linked awards. An observer experiences excitement and anticipation as new symbols land in the array, trigger an award selection from the set of available awards, and one or more new awards are generated and added to the set of available awards, providing new opportunities for future awards. In stark contrast to conventional reel-spinning games in which symbol images are evaluated for winning combinations by paytable rules, the disclosed embodiments provide immediately recognizable values in WYSIWYG display configurations while adding variability as to how the values to be awarded to the player are selected and accumulated.

The value-generation and award selection procedure may be symbol- and game-agnostic. Themes and imagery of symbols and environment may be varied with no effect on the value-generation and award selection process. Or, if so desired, the criteria for the procedure may be modified in innumerable ways to produce new visual/animation effects and exciting summation sequences.

Further benefits are realized in increased computer processing efficiency, fewer rules to be evaluated, and simpler graphical representations. For example, in a conventional paytable evaluation, overlapping payline sections require multiple evaluation steps. Often, analysis is required to determine which payline results in the highest credit total, with the lesser value paylines being discarded but only after being evaluated-all this adds to processing overhead. Special symbols like wilds, multipliers, and scatter symbols can modify paytable values and may require separate, additional evaluation according to customized rule sets. All these procedures can be inherently more complex than simple accumulation of number values and generation of new awards through predetermined, stored criteria. The embodiments disclosed herein represent a win-win: simpler, almost self-explanatory graphics combined with faster, more efficient processing. The inventive value-generation and award selection procedure can be implemented on the vast majority of casino gaming machines without requiring upgrades or modifications.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a presentation assembly configured to present a game interface including a plurality of symbol positions and a set of available awards separate from the plurality of symbol positions, each award of the set of available awards visually indicated by award indicia of a respective award element; and
game-logic circuitry in communication with the presentation assembly, the game-logic circuitry configured to:
cause the presentation assembly to present a game outcome by populating, via one or more animations, the plurality of symbol positions with randomly selected symbols;
in response to detecting a collection event based on the randomly selected symbols, cause the presentation assembly to:
remove a plurality of award elements associated with the collection event from the set of available awards presented on the game interface; and
present a new award element within the set of available awards, the new award element having award indicia visually indicating a new award at least partially as a function of the awards associated with the plurality of award elements; and
in response to detecting an award event associated with the new award element from a subsequent game outcome, cause the presentation assembly to present an award sequence for the new award.

2. The gaming machine of claim 1, wherein the collection event is an award event associated with the plurality of award elements, and wherein removing the plurality of award elements includes presenting, via the presentation assembly, an award sequence for an award based on the plurality of award elements.

3. The gaming machine of claim 1, wherein the new award is an aggregate of the awards visually indicated by the plurality of award elements.

4. The gaming machine of claim 1, wherein the collection event includes detecting a collection symbol within the randomly selected symbols.

5. The gaming machine of claim 4, wherein removing the plurality of award elements includes visually updating the collection symbol with award indicia visually indicating an award at least partially as a function of the awards of the plurality of award elements.

6. The gaming machine of claim 1, wherein the set of available awards are organized into a queue of award elements, and wherein the plurality of award elements is associated with the collection event based on a relative position of the plurality of award elements within the queue of award elements.

7. The gaming machine of claim 1, wherein the set of available awards is arranged within one or more groups of available awards, each of the one or more groups comprising an award wheel, an award reel strip, or a selectable award options, and wherein the plurality of award elements are visually indicated by a selection sequence in response to the collection event, the selection sequence animating the one or more groups of available awards.

8. A method for operating a gaming machine of a gaming system, the gaming system comprising game-logic circuitry in communication with a presentation assembly of the gaming machine, the method comprising:
presenting, via the presentation assembly, a game interface including a plurality of symbol positions and a set of available awards separate from the plurality of symbol positions, each award of the set of available awards visually indicated by award indicia of a respective award element; a
causing, by the game-logic circuitry, the presentation assembly to present a game outcome by populating, via one or more animations, the plurality of symbol positions with randomly selected symbols;
in response to detecting a collection event based on the randomly selected symbols, causing, by the game-logic circuitry, the presentation assembly to:
remove a plurality of award elements associated with the collection event from the set of available awards presented on the game interface; and
present a new award element within the set of available awards, the new award element having award indicia visually indicating a new award at least partially as a function of the awards associated with the plurality of award elements; and
in response to detecting an award event associated with the new award element from a subsequent game outcome, causing, by the game-logic circuitry, the presentation assembly to present an award sequence for the new award.

9. The method of claim 8, wherein the collection event is an award event associated with the plurality of award elements, and wherein removing the plurality of award elements includes presenting, via the presentation assembly, an award sequence for an award based on the plurality of award elements.

10. The method of claim 8, wherein the new award is an aggregate of the awards visually indicated by the plurality of award elements.

11. The method of claim 8, wherein the collection event includes detecting a collection symbol within the randomly selected symbols.

12. The method of claim 11, wherein removing the plurality of award elements includes visually updating, via the presentation assembly, the collection symbol with award indicia visually indicating an award at least partially as a function of the awards of the plurality of award elements.

13. The method of claim 8, wherein the set of available awards are organized into a queue of award elements, and wherein the plurality of award elements is associated with the collection event based on a relative position of the plurality of award elements within the queue of award elements.

14. The method of claim 8, wherein the set of available awards is arranged within one or more groups of available awards, each of the one or more groups comprising an award wheel, an award reel strip, or a selectable award options, and wherein the plurality of award elements are visually indicated by a selection sequence in response to the collection event, the selection sequence animating the one or more groups of available awards.

15. A gaming system comprising:
a gaming machine comprising a presentation assembly configured to present a game interface including a plurality of symbol positions and a set of available awards separate from the plurality of symbol positions, each award of the set of available awards visually indicated by award indicia of a respective award element; and
game-logic circuitry in communication with the presentation assembly, the game-logic circuitry configured to:
cause the presentation assembly to present a game outcome by populating, via one or more animations, the plurality of symbol positions with randomly selected symbols;
in response to detecting a collection event based on the randomly selected symbols, cause the presentation assembly to:
remove a plurality of award elements associated with the collection event from the set of available awards presented on the game interface; and
present a new award element within the set of available awards, the new award element having award indicia visually indicating a new award at least partially as a function of the awards associated with the plurality of award elements; and
in response to detecting an award event associated with the new award element from a subsequent game outcome, cause the presentation assembly to present an award sequence for the new award.

16. The gaming system of claim 15, wherein the collection event is an award event associated with the plurality of award elements, and wherein removing the plurality of award elements includes presenting, via the presentation assembly, an award sequence for an award based on the plurality of award elements.

17. The gaming machine of claim 15, wherein the new award is an aggregate of the awards visually indicated by the plurality of award elements.

18. The gaming machine of claim 15, wherein the collection event includes detecting a collection symbol within the randomly selected symbols.

19. The gaming machine of claim 18, wherein removing the plurality of award elements includes visually updating the collection symbol with award indicia visually indicating an award at least partially as a function of the awards of the plurality of award elements.

20. The gaming system of claim 15, wherein the set of available awards are organized into a queue of award elements, and wherein the plurality of award elements is associated with the collection event based on a relative position of the plurality of award elements within the queue of award elements.

21. The gaming system of claim 15, wherein the set of available awards is arranged within one or more groups of available awards, each of the one or more groups comprising an award wheel, an award reel strip, or a selectable award options, and wherein the plurality of award elements are visually indicated by a selection sequence in response to the collection event, the selection sequence animating the one or more groups of available awards.
